(19) United States
(12) Patent Application Publication
(10) Pub. No.: US 2026/0350854 A1
(43) Pub. Date: Nov. 5, 2026

(54) Automatic Model Retrieval to Enhance Image Generation

(71) Applicant: Dell Products L.P., Round Rock, TX (US)

(72) Inventors: Leandro Takeshi Hattori, Campo Grande (BR); Alisson Linhares de Carvalho, Aracaju (BR); Juarez Monteiro dos Santos Júnior, Tramandaí (BR)

(73) Assignee: Dell Products L.P., Round Rock, TX (US)

(21) Appl. No.: 19/196,353

(22) Filed: May 1, 2025

(51) Int. Cl. G06T 11/00; G06F 40/295

(52) U.S. Cl. CPC G06T 11/00; G06F 40/295; G06T 2211/441

(57) ABSTRACT

Techniques are disclosed for automatic model retrieval to enhance image generation. An example system includes a memory having instructions, and a processor communicatively coupled to the memory and configured to execute the instructions. The instructions can include extracting structured information from a received user query to generate a query set, using the query set to identify combinations of machine learning (ML) models and prompt tuning techniques, using the identified combinations of models and prompt tuning techniques to retrieve a recommended combination of an ML-based image model and a prompt tuning technique, and using the recommended image model and prompt tuning technique from the recommended combination to generate an image.

### FIELD

Example embodiments generally relate to machine learning image model retrieval. More specifically, at least some embodiments relate to systems, hardware, software, computer-readable media, and methods for automatically retrieving and applying specialized machine learning image generation models based on user queries.

### BACKGROUND

Image generation technology has evolved with the development of diffusion models for creating high-quality images from textual descriptions. These models utilize advanced algorithms to iteratively refine images based on user prompts, making them valuable tools for artists, marketers, and educators. Example technologies in this field include Stable Diffusion, which produces detailed and coherent visuals by using pre-trained checkpoint models that have learned patterns from vast amounts of training data.

### SUMMARY

Techniques are disclosed for automatic model retrieval to enhance image generation.

In one embodiment, a system includes a memory having instructions, and a processor communicatively coupled to the memory and configured to execute the instructions. The instructions can include extracting structured information from a received user query to generate a query set, using the query set to identify combinations of machine learning (ML) models and prompt tuning techniques, using the identified combinations of models and prompt tuning techniques to retrieve a recommended combination of an ML-based image model and a prompt tuning technique, and using the recommended image model and prompt tuning technique from the recommended combination to generate an image.

In some embodiments, the instructions further include displaying the image in a user interface. The user query can include a text prompt, and extracting the structured information can include using named entity recognition to extract a content description from the text prompt to include in the structured information. The structured information can include a content description, image style information, and an embedding vector. The structured information can include one or more predetermined trigger words, and the query set can incorporate the trigger words into the image style information and into the content description. The user query can include a text prompt, the structured information can include a content description and an embedding vector, and the query set can be generated using multimodal hybrid search. The multimodal hybrid search can include using an ML-based language model to refine the content description into a content description prompt, using an ML-based embedding model to generate the embedding vector from the text prompt, and including the content description prompt and the embedding vector in the structured information to generate the query set. The user query can be a multimodal query, the user query can further includes an input image, and the multimodal hybrid search can include using the embedding model to generate the embedding vector from the input image. The language model can be a mixture-of-experts model or a sparse mixture-of-experts model, and the embedding model can be a multimodal vision and language model or a retrieval-augmented large language model. The structured information can include base model information, and the combinations of models and prompt tuning techniques can be identified using the base model information to pair a given prompt tuning technique with a corresponding model. The recommended combination of the image model and prompt tuning technique can be retrieved using predetermined correlation thresholds to filter the identified combinations of models and prompt tuning techniques and obtain the recommended combination. The query set can include a content description prompt, the recommended combination can include multiple pairs of recommended image models and prompt tuning techniques, and the generated image can be a set of images. the set of images is generated by, for each pair of recommended image model and prompt tuning technique, using the content description prompt and the recommended prompt tuning technique to obtain a tuned prompt, and using the recommended image model to iteratively generate images for the set of images from the tuned prompt. The models included in the combinations of models and prompt tuning techniques can be identified using model information obtained from a model repository, and the model information can include one or more of: a model name, a model type, model keywords, base model information, trigger words, example images, model notes, a model file, and a recommended model configuration. The model information and prompt tuning techniques are stored in a database, and the recommended combination of the image model and the prompt tuning technique can be retrieved from the database.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example retrieval system, in accordance with illustrative embodiments.

FIG. 2 discloses aspects of an example model repository, in accordance with illustrative embodiments.

FIG. 3 discloses aspects of an example multimodal hybrid search, in accordance with illustrative embodiments.

FIG. 4 discloses aspects of an example model retrieval architecture, in accordance with illustrative embodiments.

FIG. 5 discloses aspects of an example image generation architecture, in accordance with illustrative embodiments.

FIG. 6 discloses a flowchart of an example method, in accordance with illustrative embodiments.

FIG. 7 discloses aspects of example generated images using the present retrieval system, in accordance with illustrative embodiments.

FIG. 8 discloses aspects of a computing entity configured and operable to perform any of the disclosed methods, processes, and operations, in accordance with illustrative embodiments.

### DETAILED DESCRIPTION

Example embodiments generally relate to machine learning image model retrieval. More specifically, at least some embodiments relate to systems, hardware, software, computer-readable media, and methods for automatically retrieving and applying specialized machine learning image generation models based on user queries. Disclosed herein are techniques for automatic model retrieval to enhance image generation.

In recent years, there have been significant advances in diffusion models to generate images. These models have quickly become an essential tool for artists and hobbyists, enriching their creative workflows in several fields, including educational and marketing materials. Part of this progress can be attributed to the popularization of fine-tuning base models (checkpoints) and Low-Rank Adaptation (LoRA) models trained with specific styles. These models allow users to generate high-quality images by running significantly smaller base models on personal computers.

The ease of creating a fine-tuning model has fostered a large community of users contributing different checkpoints and LoRAs. Model repositories such as Civitai facilitate this community, allowing users to share their models along with sample images and relevant metadata.

Given the numerous contributions from these communities, a technical problem involves the difficulty of finding a suitable combination of a base model, LoRAs, prompts, and settings that match the user's desired output. This search process is often trial-and-error, requiring significant user time and effort. Consequently, repeated work overloads technical infrastructure, expends energy, and wastes resources.

Conventional image generation is typically performed manually in a trial-and-error approach or through a pre-configured image generation pipeline, removing the flexibility of leveraging community models and effort.

Described herein are model retrieval techniques to overcome these limitations. Example embodiments utilize a hybrid search implementation combined with a reconfigurable image generation pipeline to identify a recommended combination of LoRAs, checkpoints, and settings for a given prompt. Advantageously, the present solution is operable to pre-select styles and elements closely aligned with the user's intentions, reducing user effort, and improving quality of the generated images.

Several companies use image generation models to tackle different tasks in production pipelines such as personalized marketing content and product recommendation via generated images, as well as using such models to generate propaganda through videos and special effects in cinematographic industry.

Example embodiments offer a dynamic scaling Artificial Intelligence (AI) service for image generation tasks applicable to a vast range of applications that are ripe for improvement. The disclosed dynamic features can meet a broad range of user requirements, making image generation technology accessible to a wider audience and promoting broader adoption.

The disclosed techniques address the technical problems above by providing a technical solution that includes, but is not limited to:
An automatic model retrieval system to guide image generation: example embodiments extract information from a user prompt and employ hybrid search to find recommended models and configurations for generating an image. In some embodiments, after the search related models are combined, enforcing specific characteristics into the final image.
Prompt tuning based on model specifications: example embodiments automatically include specific tags in the prompt according to the models'specifications. Advantageously, this helps improve the final prompt and better guide the checkpoints toward the desired goal. In some embodiments, the present solution can also be extended to use custom LoRAs and negative embeddings to further enhance the final image, removing artifacts and fixing common issues.
Automatically generated offline database organization for storing models and configurations: example embodiments employ a database with pre-configured models and settings that is utilized by the present image generation pipeline to improve image consistency among generations. In some embodiments this database is constructed using an automatic pipeline that searches for candidate models and their recommended settings.

In contrast to conventional proprietary and open-source alternatives, example embodiments provide a two-stage solution to combine the best characteristics of both worlds: flexibility of open-source models and simplicity of proprietary solutions. In one implementation, the present system utilizes a two-stage sophisticated pipeline, with an offline stage responsible for building a database containing configurations and image generation models, and an online stage responsible for identifying and selecting recommended image models and configurations for a given prompt. Advantageously, the present system provides an automatic solution available to map the user's choice directly to a recommended checkpoint, LoRA, embeddings and their respective configurations, to produce an image with the chosen features. Moreover, the disclosed approach is more flexible and can be easily applied in other similar generative problems, such as video and mesh generation.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. References

Reference is made herein to various documents, which are listed below. These documents are incorporated herein in their respective entireties by this reference.
[1] Chen, J., Xiao, S., Zhang, P., et al. (2024). BGE M3-Embedding: Multi-Lingual, Multi-Functionality, Multi-Granularity Text Embeddings Through Self-Knowledge Distillation [Preprint]. arXiv, arxiv.org/abs/2402.03216
[2] Rombach, Robin, et al. “High-resolution image synthesis with latent diffusion models.” Proceedings of the IEEE/CVF conference on computer vision and pattern recognition. 2022.
[3] Midjourney. (n.d.). Midjourney. www.midjourney.com/home
[4] OpenAI. (n.d.). DALL·E 2. openai.com/index/dall-e-2/
[5] Zhang, Lvmin, Anyi Rao, and Maneesh Agrawala. “Adding conditional control to text-to-image diffusion models.” Proceedings of the IEEE/CVF International Conference on Computer Vision. 2023.
[6] Ye, Hu, et al. “Ip-adapter: Text compatible image prompt adapter for text-to-image diffusion models.” arXiv preprint arXiv:2308.06721 (2023).
[7] Hu, Edward J., et al. “Lora: Low-rank adaptation of large language models.” arXiv preprint arXiv:2106.09685 (2021).
[8] comfyanonymous. (n.d.). ComfyUI. GitHub. github. com/comfyanonymous/ComfyUI
[9] AUTOMATIC1111. (n.d.). Stable Diffusion WebUI. Github. github.com/AUTOMATIC1111/stable-diffusion-webui

### B. Context for One or More Embodiments

The following is a discussion of a context for example embodiments. This discussion is not intended to limit the scope of the invention, or the applicability of the embodiments, in any way.

Conventional proprietary platforms for image generation based on diffusion models are available, with popular examples including Stable Diffusion [2], Midjourney [3], and DALL-E [4]. These platforms offer high levels of abstraction through user-friendly text interfaces, enabling users to generate images in seconds while providing various controls over their creations, such as inpainting, outpainting, image blending, generating variations, and more.

Similarly, conventional open-source software options include ControlNets, IPAdapters [6], LoRAs [7], embeddings, and custom checkpoints. Now, professionals and enthusiasts can make use of various technologies and models to enhance image and video generation. In addition, open-source interfaces such as ComfyUI [8] and Automatic1111 [9] offer extensive control compared with major proprietary platforms, enabling users to configure all aspects of the image generation process. This control includes combining checkpoints, LoRAs, and embeddings in different orders.

However, unlike conventional proprietary solutions that can rely on a limited number of models, making the experience more restricted and user-friendly, conventional open-source alternatives provide thousands of specialized checkpoints, LoRAs, and embeddings that can be used to mimic specific image styles. Each model includes predetermined optimal configurations that must be met for successful image generation, and this number will likely grow in the coming years due to popularity of fine-tuning tools and advancements in hardware.

### B.1. Stable Diffusion

Stable Diffusion is a machine learning technique used to generate high-quality images based on textual descriptions provided by a user. Stable Diffusion utilizes algorithms to iteratively refine an image until it closely matches the given prompt. This method produces detailed and coherent visuals, making it a useful tool for artists, marketers, and educators. Stable Diffusion's ability to create images from text inputs opens new possibilities for creative expression and practical applications, such as generating marketing materials, educational content, and digital artwork.

### B.2. Checkpoints

Checkpoints in machine learning refer to pre-trained models that serve as starting points for further training or fine-tuning. These models have already learned patterns and features from vast amounts of data, making them effective for various tasks, such as image generation, text analysis, or speech recognition. By using checkpoints, developers can save time and resources since they do not need to train a model from scratch. Instead, they can leverage the existing knowledge embedded in the checkpoint and adjust it to fit specific needs or styles. This process enhances efficiency and accuracy, enabling more rapid deployment of AI applications across different fields.

### B.3. Prompt Tuning

Prompt tuning refers to the process of fine-tuning machine learning models to better respond to specific types of inputs or prompts. Techniques such as Low-Rank Adaptation (LoRA), Domain-Oriented Robust Adaptation (DORA), embeddings, and prompt tuning itself are employed to tailor the model's behavior and output. In image generation, this type of approach sometimes uses specific keywords (for example, trigger words) during the training. These keywords can be used in the prompt to obtain the desired intention in the content. LoRA and DORA adjust the model's parameters to focus on styles or domains, while embeddings represent words or phrases in a format that the model can understand. Prompt tuning involves directly modifying the input prompts to guide the model toward desired outputs. These techniques enable more precise and relevant responses, enhancing the model's performance and applicability in various contexts.

### B.4. Low-rank Adaptation (LoRA)

Low-Rank Adaptation (LoRA) is a technique used to fine-tune pre-trained models for specific styles or tasks by introducing minor adjustments rather than retraining the entire model. LoRA focuses on adapting the model's parameters in a cost-effective and resource-efficient manner. LoRA achieves this by identifying the most relevant aspects of the model's knowledge and modifying those aspects to better suit particular requirements, such as artistic styles or domain-specific language. This selective adaptation ensures high-quality output while minimizing computational burden, making the technique feasible for use on personal computers and accessible to a broader range of users.

### B.5. Named Entity Recognition

Named Entity Recognition (NER) is a field of study related to natural language processing. The objective of named entity recognition is to locate and classify named entities mentioned in unstructured text into predefined categories. These categories can include names of people, organizations, locations, dates, times, quantities, monetary values, percentages, scientific terms, product names, and more. Unlike conventional NER models, which require labeled training data for specific entity types, zero-shot NER classifiers can recognize entities without any training examples. This is the case for projects like NuZero, which can achieve good performance results across different domains.

### C. Overview of Aspects of One or More Embodiments

Described herein is an automatic model retrieval system to enhance image generation. In one implementation, the present retrieval approach is divided into offline and online phases.

Example embodiments of the offline phase are responsible for adding models to the system database, which is an aspect that increases the probability of the present framework retrieving more suitable models for image generation based on user intention. Example embodiments of the online phase are responsible for transforming the raw user query into structured intention information, enabling more appropriate model retrieval. The disclosed techniques address these two phases with a coupled solution that is generic and can be easily incorporated into enterprise AI systems.

The disclosed techniques introduce model retrieval into image generation. In this sense, advantageously the present solution couples automatic information extraction from the user query with model databases to enhance image generation capacity. The present approach creates better quality human experiences for non-experts, making these AI tools accessible for higher-level users and more efficient image generation at scale for different user types.

Disclosed herein is an automatic model retrieval system to enhance image generation. In a broader perspective, the present solution receives an input prompt, which may or may not include images, and outputs one or more final images that include the user's desired characteristics. To achieve this goal, one implementation of the present system employs four general components:
I. Multimodal Hybrid Search: responsible for breaking down the user query and performing a hybrid search in a model database.
II. Model Retrieval: responsible for fetching recommended models to be used in the image generation pipeline, along with recommended settings for using each model.
III. An image generation pipeline: capable of swapping and combining checkpoints, LoRAs and embeddings dynamically.
IV. Web Crawling Tool: a component responsible for downloading models from open-source repositories, including main configuration elements such as CFG (Classifier Free Guidance Scale), number of steps, recommended VAE (Variational Autoencoder), scheduler configuration, and trigger words to be added to positive or negative prompts to activate models. This component is an addition to the present solution for better describing the database and architecture internals. In some embodiments the web crawling component could be replaced by a well-defined offline structured database if available.

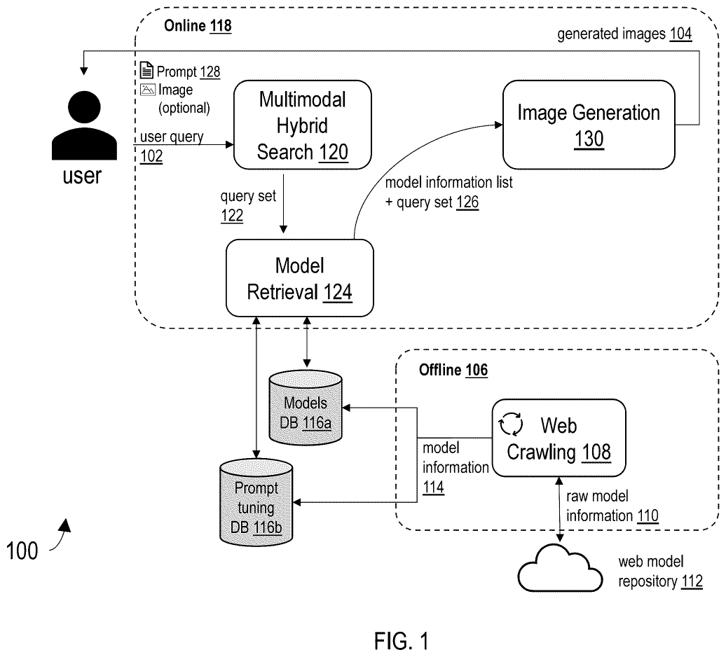

FIG. 1 shows aspects of an example model retrieval system 100, in accordance with illustrative embodiments. To simplify comprehension of the present system, FIG. 1 shows an overview of example components and functionalities in the present retrieval system. In particular, FIG. 1 illustrates the present solution configured to process a user query 102 and generate one or more images 104.

Example embodiments start with an offline phase 106. In this phase, a web crawling module 108 downloads raw model information 110 from different model repositories 112 and transforms the raw model information into processed model information 114. Some embodiments store this model information in various databases 116a, 116b (collectively, 116).

In example embodiments, during an online phase 118, a multimodal hybrid search module 120 receives the user query 102 and extracts structured information into a query set 122. A model retrieval module 124 uses the query set information to match with the database model information obtained from the databases 116 and returns the model information list and query set 126 that are most semantically close to the user prompt 128 contained in the user query.

Example embodiments of an image generation module 130 use the model information list, which contains the models'details, and the query set, which contains the user query, to generate different images 104 using the models retrieved in the previous step. The generated images are then sent to the user, for example by displaying the generated images in a user interface or by making available the generated images for download by the user.

Described herein is one implementation of four components: multimodal hybrid search 120, model retrieval 124, web crawling and database reconstruction 108 for fast model retrieval, and an image generation custom pipeline 130. Each component is discussed in further detail herein, including an example model retrieval highlighting the benefits of the disclosed retrieval techniques (section F).

In example embodiments, a service can implement the present model retrieval techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees), linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations.

In some implementations, the service is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

### D. Detailed Discussion of Aspects of One or More Embodiments

### D.1. Offline Phase

Example embodiments of the offline phase include a web crawling activity (an example of the web crawling module 108 (FIG. 1)), where a goal is to gather models and prompt tuning approaches along with their respective metadata from model repositories. Example model repositories include, but are not limited to, Civitai and Hugging Face. In some embodiments, these downloads are manually supervised by humans. In other embodiments, these downloads are automated using web crawler libraries such as Beautiful Soup.

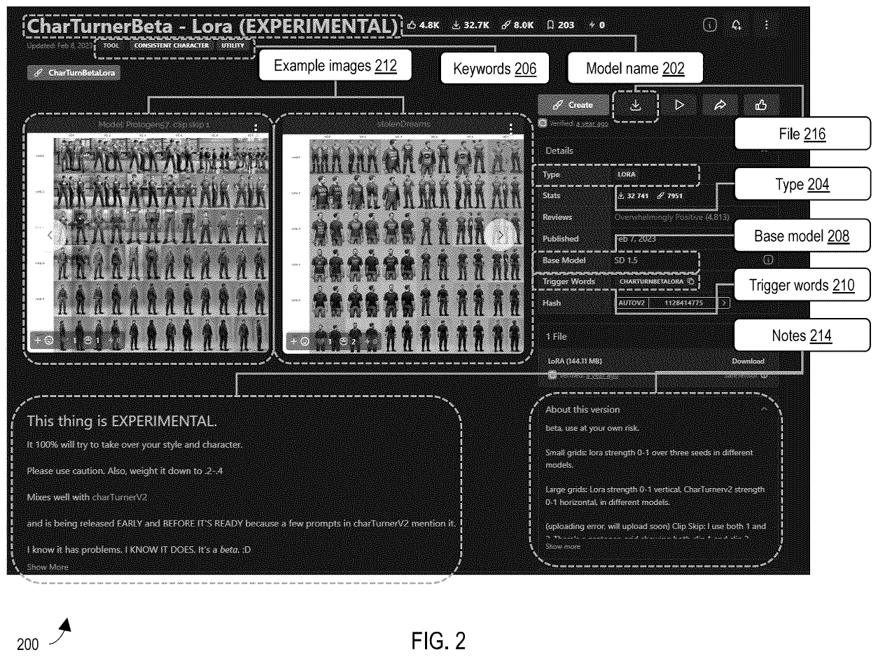

FIG. 2 shows aspects of an example model repository 200, in accordance with illustrative embodiments. In particular, FIG. 2 shows an example of a Civitai webpage with a LoRA model with its metadata to be extracted.

FIG. 2 highlights example raw model information to be extracted. Example embodiments of raw model information include the model or prompt tuning approach files and their respective metadata. Example metadata includes, but is not limited to the following:
Model name 202: A name or title of the model or prompt tuning approach.
Model type 204: A type of the approach. For example, checkpoints, LoRA, DORA, embeddings, and the like.
Model keywords 206: Words that identify the specific model. For example, photorealistic, anime, animal, and the like.
Base model information 208: The model used for a given approach. For example, SD (Stable Diffusion) 1.5 hyper, SDXL 1.0, and the like.
Trigger words 210: Special tokens used in prompts to dynamically replace the tokens with specific content during text generation. For example, IRISHI, loraeyes, and the like.
Example images 212: A list of example images demonstrating the model's capabilities.
Model notes 214: notes that the creator of the prompt technique left for the user.

Some embodiments of the notes contain the information about the stylization and the scenario that the models was trained.
Model file 216: the file of the checkpoint or the prompt-tuning technique.
Recommended model configuration: a recommended configuration for the sampler. An example recommended configuration includes frequently used tags, CFG scale, steps, and the scheduler used with the model, which typically results in better image outputs.

With reference to FIG. 1, in one implementation the extracted model information is stored in different databases 116. For example, the checkpoints are stored in the model database 116a, and the prompt tuning technique such as embeddings, LoRAs, DORAs, and other prompt tuning techniques, are stored in the prompt tuning database 116b.

### D.2. Online Phase

With reference to FIG. 1, in one implementation the online phase 118 generally includes three steps. First, the present system receives a user query 102 and sends the user query to the multimodal hybrid search module 120. The multimodal hybrid search module extracts the query set 122, which is then used to retrieve models using the model retrieval module 124. Next, the query set is analyzed, and with access to the models database 116a and the prompt tuning database 116b, a list of recommended approaches (e.g., a model information list) is retrieved. Lastly, this model information, along with the query set 126, is sent to the image generation module 130 to generate a set of images (for example, the generated images 104) that will be sent to the user.

### D.2.1. Multimodal Hybrid Search

In example embodiments, a goal of this multimodal hybrid search phase is to generate a query set that enables retrieving a recommended model for image generation.

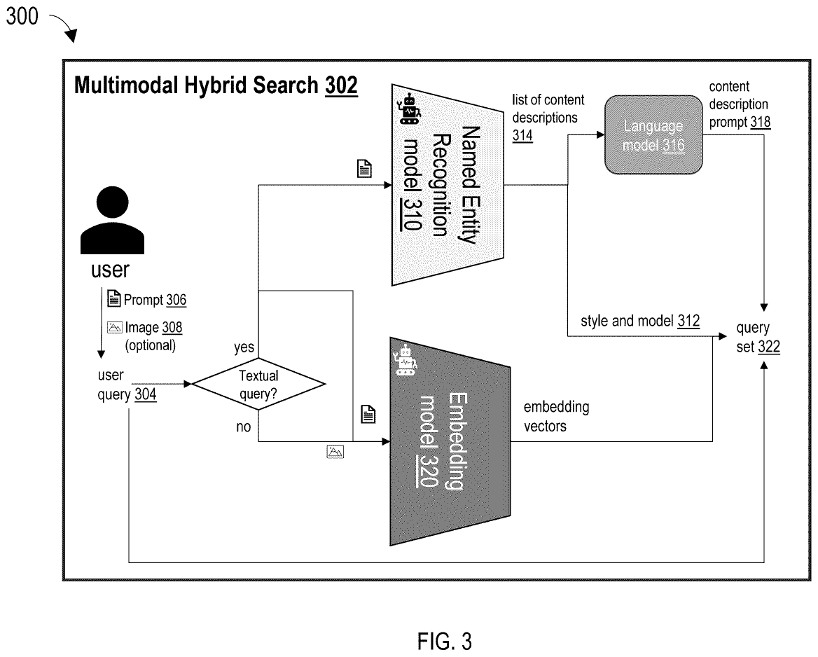

FIG. 3 shows aspects of an example multimodal hybrid search 300, in accordance with illustrative embodiments. In particular, FIG. 3 shows an example multimodal hybrid search module 302 (an example of the multimodal hybrid search module 120 (FIG. 1)) with its respective input, strategy, and output.

In example embodiments, a user provides a user query 304 consisting of a textual prompt 306 and an image 308. In some embodiments, the textual prompt is mandatory and the image is optional.

In one implementation, the textual information is sent to a Named Entity Recognition (NER) model 310 to extract the prompt's intention, including image style and model information 312. The prompt's intention is sometimes referred to herein as semantic intention. In some embodiments, the NER model is a zero-shot NER classifier model. In one example, the NER model is NuZero.

In one implementation, if the caption is broken into distinct parts, the NER model is configured to generate a list of content descriptions 314. In further embodiments, the content descriptions are refined using a language model 316 to generate a coherent content description prompt 318. In some embodiments, the language model is an LLM such as a mixture-of-experts (MoE) model or a sparse mixture-of-experts (SMoE) model. For example, the language model can include the Mixtral or Llama models.

In one implementation, an embedding model 320 is configured to extract the semantic intention of the user in order to enhance the hybrid search of the configurations and models. In one implementation, the embedding model is a textual embedding model. In some embodiments, the embedding model is a multimodal model such as a multimodal vision and language model or a retrieval-augmented LLM. For example, the textual embedding model can include the CLIP or BGE-M3 models. In one implementation, the embedding model is an image embedding model. The image embedding model can include the CLIP model.

Example embodiments compile this generated information into a query set 322 to be used in the image generation pipeline. In some embodiments, the query set is compiled in a dictionary format.

### D.2.2. Model Retrieval

In example embodiments, a goal of this model retrieval phase is to identify suitable image generation approaches based on information contained in the query set. Example information can include, but is not limited to, image style, model preferences, content description prompt, textual embedding, and optionally, image embedding.

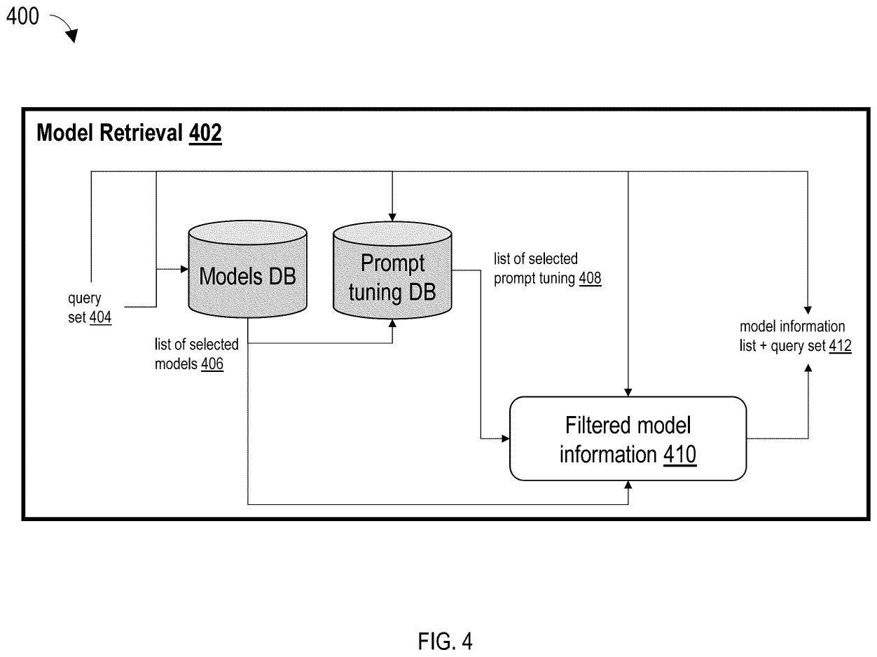

FIG. 4 shows aspects of an example model retrieval 400, in accordance with illustrative embodiments. In particular, FIG. 4 shows an example model retrieval module 402 (an example of the model retrieval module 124 (FIG. 1)) with its respective inputs, strategy, and output.

Example embodiments identify combinations of models and prompt tuning techniques using the query set. In one implementation, the model retrieval module 402 retrieves, initially, models aligned with the query set 404 information, resulting in a candidate list of selected models 406. Concurrently, the model retrieval module identifies suitable prompt tuning techniques based on the query set, yielding a candidate list of applicable prompt tuning techniques 408. The selected models 406 and prompt tuning techniques 408 proceed to a filtered model information step 410. Here, each prompt tuning approach is paired with its corresponding models using base model information to obtain the identified combinations.

Example embodiments retrieve recommended combinations of image models and prompt tuning techniques using the identified combinations. Some embodiments obtain the recommended combinations by filtering out identified combinations that do not exhibit strong correlations based on predefined thresholds. In further embodiments, the thresholds can include considering the number of images to be generated. In some embodiments, the capacity for image generation varies depending on the use case. For example, a robust server infrastructure can allow for generating more images, whereas stricter technical or system requirements can result in fewer options and a higher correlation threshold.

Finally, example embodiments store the recommended combinations of models, prompt tuning techniques, and their respective metadata in the model information and query set 412. The model information and query set are then forwarded to the subsequent phase.

### D.2.3. Image Generation

In example embodiments, a goal of this image generation phase is to produce a series of images using the model information list and the content description prompt extracted from the query set.

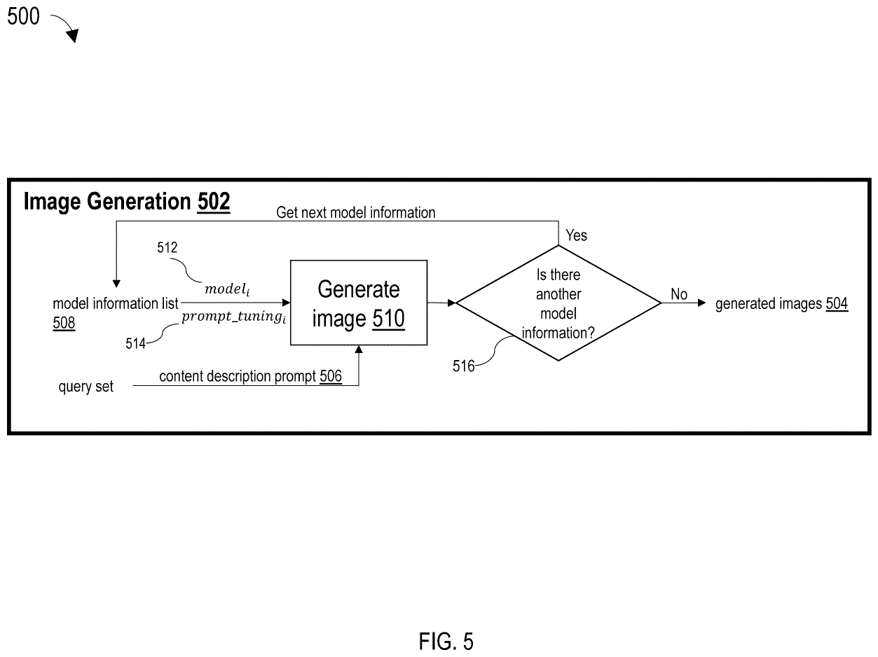

FIG. 5 shows aspects of an example image generation 500, in accordance with illustrative embodiments. In particular, FIG. 5 shows an example image generation module 502 (an example of the image generation module 130 (FIG. 1)) with its respective inputs, strategy, and output.

Example embodiments generate an image using the recommended combination of image models and prompt tuning techniques. In one implementation, the image generation phase entails iterative image generation processes where each recommended combination of image model 512 and prompt tuning technique 514 generates a set of images 504. The content description prompt 506 serves as input for each image generation iteration. If trigger words are specified, they are incorporated into the content description and image style to guide the image generation process 510 accordingly. This iterative process continues 516 until all image models in the information list 508 have been utilized. Subsequently, the resultant list of images 504 is delivered to the user.

### E. Example Methods

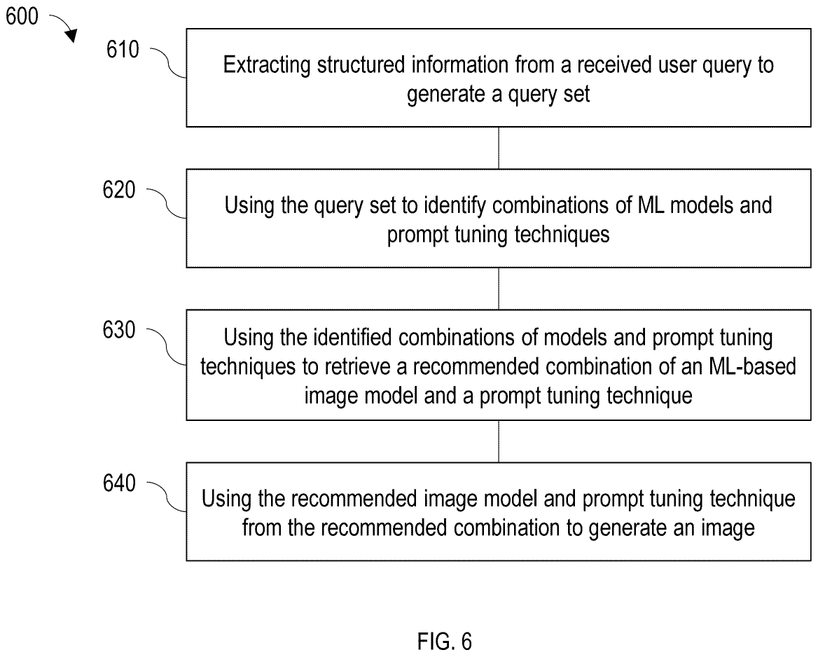

FIG. 6 shows a flowchart of an example method 600, in accordance with illustrative embodiments. In example embodiments, the method 600 allows for enhanced image generation by automatically retrieving recommended combinations of image models and prompt tuning techniques.

In some embodiments, the method 600 is performed by the retrieval system 100 (FIG. 1).

In example embodiments, the method 600 includes extracting structured information from a received user query to generate a query set (step 610). In some embodiments, the user query includes a text prompt, and extracting the structured information includes using named entity recognition to extract a content description from the text prompt to include in the structured information. In some embodiments, the structured information includes a content description, image style information, and an embedding vector. In some embodiments, the structured information includes one or more predetermined trigger words, and the query set incorporates the trigger words into the image style information and into the content description. In some embodiments, the user query includes a text prompt, the structured information includes a content description and an embedding vector, and the query set is generated using multimodal hybrid search. In further embodiments, the multimodal hybrid search includes using an ML-based language model to refine the content description into a content description prompt, using an ML-based embedding model to generate the embedding vector from the text prompt, and including the content description prompt and the embedding vector in the structured information to generate the query set. In yet further embodiments, the language model is a mixture-of-experts model or a sparse mixture-of-experts model; and the embedding model is a multimodal vision and language model or a retrieval-augmented large language model. In still further embodiments, the user query is a multimodal query and the user query further includes an input image, and the multimodal hybrid search includes using the embedding model to generate the embedding vector from the input image.

In example embodiments, the method 600 includes using the query set to identify combinations of ML models and prompt tuning techniques (step 620). In some embodiments, the structured information includes base model information, and the combinations of models and prompt tuning techniques are identified using the base model information to pair a given prompt tuning technique with a corresponding model. In some embodiments, the models included in the combinations of models and prompt tuning techniques are identified using model information obtained from a model repository, and the model information includes one or more of: a model name, a model type, model keywords, base model information, trigger words, example images, model notes, a model file, and a recommended model configuration.

In example embodiments, the method 600 includes using the identified combinations of models and prompt tuning techniques to retrieve a recommended combination of an ML-based image model and a prompt tuning technique (step 630). In some embodiments, the recommended combination of the image model and prompt tuning technique is retrieved using predetermined correlation thresholds to filter the identified combinations of models and prompt tuning techniques and obtain the recommended combination. In some embodiments, the model information and prompt tuning techniques are stored in a database, and the recommended combination of the image model and the prompt tuning technique is retrieved from the database.

In example embodiments, the method 600 includes using the recommended image model and prompt tuning technique from the recommended combination to generate an image (step 640). In some embodiments, the query set includes a content description prompt, the recommended combination includes multiple pairs of recommended image models and prompt tuning techniques, and the generated image is a set of images. In further embodiments, the set of images is generated by, for each pair of recommended image model and prompt tuning technique, using the content description prompt and the recommended prompt tuning technique to obtain a tuned prompt, and using the recommended image model to iteratively generate images for the set of images from the tuned prompt.

In further embodiments, the method 600 includes displaying the image in a user interface.

While the various steps in the example method 600 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 600 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### F. Example Model Retrieval

This section describes an example model retrieval using the present retrieval system. Example events that occur in the present retrieval workflow are described in detail. The example model retrieval describes a particular scenario in which a user sent a textual prompt to the present system.

The example model retrieval proceeds with the steps described below:
1. During an offline phase, the web crawling module constantly acquires new models.

In example embodiments, the web crawling module processes a JSON document that contains an HTML file with the model information. Example metadata processed from an online model repository includes raw model information such as the following:
Raw Model Information={
   ‘file’: ‘video game franchise—SDXL.html’
}
2. Subsequently, the web crawling module extracts the metadata from the HTML file with the model information and stores the extracted metadata in a database.

Example metadata can include the following that was extracted from a model. In some embodiments, the metadata can be curated by a system administrator. In other embodiments, the metadata can be processed using a web crawling script.
Model information={
   ‘model name’: ‘video game franchise—SDXL’,
‘keyword’: [‘VIDEO GAME’, ‘FPS’, ‘FIRST PERSON SHOOTER’, ‘VIDEO GAMING’, ‘VIDEOGAME’],
‘type’: ‘SDXL 1.0’,
‘trigger Words’: ‘VIDEOGAME1024’,
‘note’: ‘a fictional character and the protagonist video game franchise of first-person shooters. He was created by American video game designer. He was introduced as the player character in the original 1993 video game. Within the series, This videogame character is a demon hunter space marine dressed in green combat armor who rarely speaks onscreen, and his personality and backstory were intentionally vague to reinforce his role as a player avatar.’,
   ‘file’: ‘video game franchise—SDXL.pth’
}
3. During an online phase, the retrieval system receives a user query from a user. For example, the user query can include a textual prompt with its intention in a JSON format.

An example textual prompt can include the following prompt received from the user:
User query={
   ‘textual’: ‘I want to generate a video game fashion showing a man and his technology using a SDXL’
}
4. The multimodal hybrid search module analyzes the JSON file with the textual prompt information. The analysis can include extracting and generating the content description prompt, along with the style and the model for use to generate the images. Additionally, the multimodal hybrid search extracts the embedding vector(s). In one implementation, the extracted information is stored in a JSON file that is sent for the model retrieval phase.

In example embodiments the feature engineering can be pre-processed by a name entity recognition model, a language model, and an embedding model, as described in further detail herein.
Query Set={
   ‘content description prompt': ‘I want to generate an image of a man with technology’,
   ‘style and model’: [‘video game fashion’, ‘a SDXL’],
   ‘embedding vectors’: [0.6, 0.5, 0.3, . . . , 0.9],
}
5. The model retrieval phase searches for more similar models and saves the model information for the similar models in a list referred to as the model information list. In one implementation, the model information list uses a JSON file format. This model information along with the query set will be sent to the image generation phase.

The example below includes the query set along with a model information list. The query set is generated using the feature engineering pre-processed by the name entity recognition model, the language model, and the embedding model. The model information list includes the retrieved models based on the query set.
Query set={
   ‘content description prompt': ‘I want to generate an image of a man with technology’,
   ‘style and model’: [‘video game fashion’, ‘a SDXL’],
   ‘embedding vectors’: [0.6, 0.5, 0.3, . . . , 0.9],
},
Model information list={
   ‘model’: [‘video game franchise-SDXL’]
}
6. The image generation phase generates images based on the model information list and its respective prompt included in the query set.

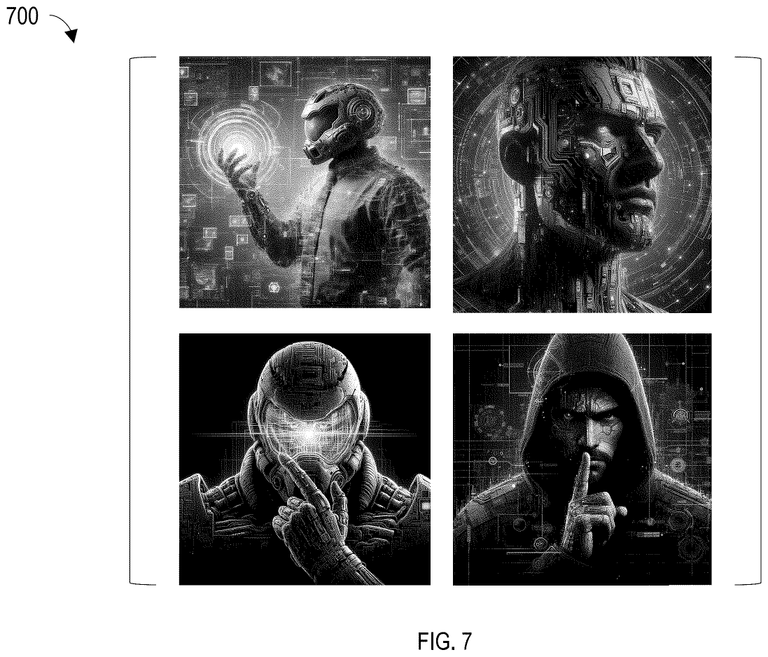

FIG. 7 shows aspects of example generated images 700 that result from the example described herein.

The image generation returns to the user the images 700 generated by the model selected in the model retrieval phase using the model information list and the query set. The query set includes the style and model and the content prompt description. In the example described herein, the selected model was the ‘video game franchise-SDXL’ model.

### G. Example Processing Platforms

At least portions of the present retrieval system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present retrieval system. For example, containers can be used to implement respective processing devices providing compute and/or storage services of a cloud-based system. Again, containers may be used in combination with other virtualization infrastructure such as virtual machines implemented using a hypervisor.

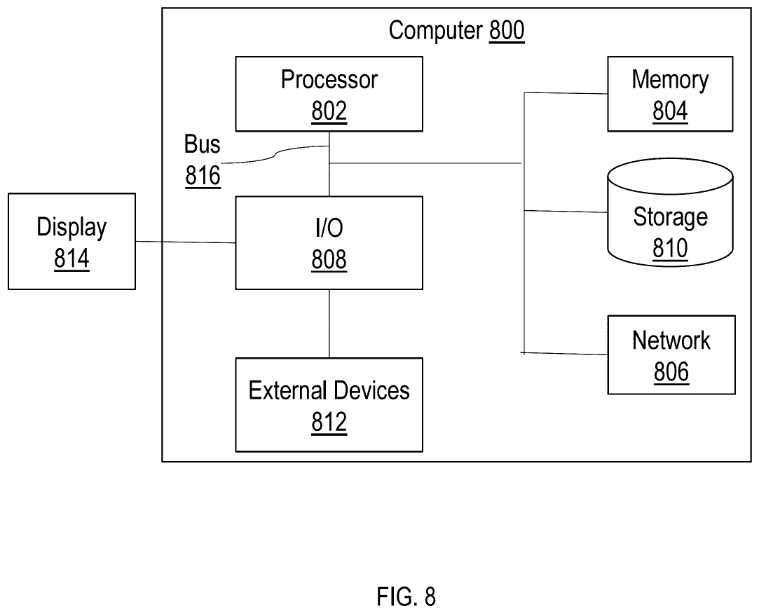

Illustrative embodiments of processing platforms will now be described in greater detail with reference to FIG. 8. Although described in the context of the present retrieval system, these platforms may also be used to implement at least portions of other information processing systems in other embodiments.

FIG. 8 illustrates aspects of a computing device or a computing system, in accordance with example embodiments. The computer 800 is shown in the form of a general-purpose computing device. Components of the computer may include, but are not limited to, one or more processors or processing units 802, a memory 804, a network interface 806, and a bus 816 that communicatively couples various system components including the system memory and the network interface to the processor.

The bus 816 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 800 typically includes a variety of computer-readable media. Such media may be any available media that is accessible by the computer system, and such media includes both volatile and non-volatile media, removable and non-removable media.

The memory 804 may include computer system readable media in the form of volatile memory, such as random-access memory (RAM) and/or cache memory. The computer system may further include other removable/non-removable, volatile/non-volatile computer system storage media. By way of example only, the storage system 810 may be provided for reading from and writing to a non-removable, non-volatile magnetic media (not shown and typically called a “hard drive”) in accordance with the present model retrieval techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 816 by one or more data media interfaces. As has been depicted and described in connection with FIGS. 1-7, the memory may include at least one computer program product having a set (e.g., at least one) of program modules that are configured to carry out the functions of the embodiments as described herein.

The computer 800 may also include a program/utility, having a set (at least one) of program modules, which may be stored in the memory 804 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 800 may also communicate with one or more external devices 812 such as a keyboard, a pointing device, a display 814, etc. ; one or more devices that enable a user to interact with the computer system; and/or any devices (e.g., network card, modem, etc.) that enable the computer system to communicate with one or more other computing devices. Such communication may occur via the Input/Output (I/O) interfaces 808. Still yet, the computer system may communicate with one or more networks such as a local area network (LAN), a general wide area network (WAN), and/or a public network (e.g., the Internet) via the network adapter 806. As depicted, the network adapter communicates with the other components of the computer system via the bus 816. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-8, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory including instructions; and
a processor communicatively coupled to the memory and configured to execute the instructions, the instructions including:
extracting structured information from a received user query to generate a query set;
using the query set to identify combinations of machine learning (ML) models and prompt tuning techniques;
using the identified combinations of models and prompt tuning techniques to retrieve a recommended combination of an ML-based image model and a prompt tuning technique; and
using the recommended image model and prompt tuning technique from the recommended combination to generate an image.

2. The system of claim 1, wherein the instructions further include displaying the image in a user interface.

3. The system of claim 1,
wherein the user query includes a text prompt, and
wherein extracting the structured information includes using named entity recognition to extract a content description from the text prompt to include in the structured information.

4. The system of claim 1, wherein the structured information includes a content description, image style information, and an embedding vector.

5. The system of claim 4,
wherein the structured information includes one or more predetermined trigger words,
wherein the query set incorporates the trigger words into the image style information and into the content description.

6. The system of claim 1,
wherein the user query includes a text prompt, and the structured information includes a content description and an embedding vector, and
wherein the query set is generated using multimodal hybrid search, the multimodal hybrid search including:
using an ML-based language model to refine the content description into a content description prompt;
using an ML-based embedding model to generate the embedding vector from the text prompt; and
including the content description prompt and the embedding vector in the structured information to generate the query set.

7. The system of claim 6,
wherein the user query is a multimodal query and the user query further includes an input image, and
wherein the multimodal hybrid search includes using the embedding model to generate the embedding vector from the input image.

8. The system of claim 6,
wherein the language model is a mixture-of-experts model or a sparse mixture-of-experts model; and
wherein the embedding model is a multimodal vision and language model or a retrieval-augmented large language model.

9. The system of claim 1,
wherein the structured information includes base model information, and
wherein the combinations of models and prompt tuning techniques are identified using the base model information to pair a given prompt tuning technique with a corresponding model.

10. The system of claim 1, wherein the recommended combination of the image model and prompt tuning technique is retrieved using predetermined correlation thresholds to filter the identified combinations of models and prompt tuning techniques and obtain the recommended combination.

11. The system of claim 1,
wherein the query set includes a content description prompt, the recommended combination includes multiple pairs of recommended image models and prompt tuning techniques, the generated image is a set of images, and
wherein the set of images is generated by:
for each pair of recommended image model and prompt tuning technique,
using the content description prompt and the recommended prompt tuning technique to obtain a tuned prompt; and
using the recommended image model to iteratively generate images for the set of images from the tuned prompt.

12. The system of claim 1,
wherein the models included in the combinations of models and prompt tuning techniques are identified using model information obtained from a model repository, and
wherein the model information includes one or more of: a model name, a model type, model keywords, base model information, trigger words, example images, model notes, a model file, and a recommended model configuration.

13. The system of claim 12, wherein the model information and prompt tuning techniques are stored in a database, and the recommended combination of the image model and the prompt tuning technique is retrieved from the database.

14. A method comprising:
extracting structured information from a received user query to generate a query set;
using the query set to identify combinations of machine learning (ML) models and prompt tuning techniques;
using the identified combinations of models and prompt tuning techniques to retrieve a recommended combination of an ML-based image model and a prompt tuning technique; and
using the recommended image model and prompt tuning technique from the recommended combination to generate an image.

15. The method of claim 14,
wherein the user query includes a text prompt, and
wherein extracting the structured information includes using named entity recognition to extract a content description from the text prompt to include in the structured information.

16. The method of claim 14,
wherein the user query includes a text prompt, and the structured information includes a content description and an embedding vector, and
wherein the query set is generated using multimodal hybrid search, the multimodal hybrid search including:
using an ML-based language model to refine the content description into a content description prompt;
using an ML-based embedding model to generate the embedding vector from the text prompt; and
including the content description prompt and the embedding vector in the structured information to generate the query set.

17. The method of claim 14,
wherein the structured information includes base model information, and
wherein the combinations of models and prompt tuning techniques are identified using the base model information to pair a given prompt tuning technique with a corresponding model.

18. The method of claim 14, wherein the recommended combination of the image model and prompt tuning technique is retrieved using predetermined correlation thresholds to filter the identified combinations of models and prompt tuning techniques and obtain the recommended combination.

19. The method of claim 14,
wherein the query set includes a content description prompt, the recommended combination includes multiple pairs of recommended image models and prompt tuning techniques, the generated image is a set of images, and
wherein the set of images is generated by:
for each pair of recommended image model and prompt tuning technique,
using the content description prompt and the recommended prompt tuning technique to obtain a tuned prompt; and
using the recommended image model to iteratively generate images for the set of images from the tuned prompt.

20. A non-transitory processor-readable storage medium having stored thereon program code of one or more software programs, wherein the program code when executed by at least one processing device causes the at least one processing device to perform the following steps:
extracting structured information from a received user query to generate a query set;
using the query set to identify combinations of machine learning (ML) models and prompt tuning techniques;
using the identified combinations of models and prompt tuning techniques to retrieve a recommended combination of an ML-based image model and a prompt tuning technique; and
using the recommended image model and prompt tuning technique from the recommended combination to generate an image.
